(19) United States
(12) Patent Application Publication
(10) Pub. No.: US 2006/0154166 A1
(43) Pub. Date: Jul. 13, 2006

(54) Toner for electrophotographic imaging apparatus

(75) Inventors: Koichi Tsunemi, Suwon-si (KR); Jun-ho Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/280,356

(22) Filed: Nov. 17, 2005

(30) Foreign Application Priority Data
Jan. 13, 2005 (KR) 10-2005-0003186

(51) Int. Cl. G03G 9/09

(52) U.S. Cl. 430/108.23; 430/111.4; 430/108.3; 430/108.7; 430/120

(57) ABSTRACT

A yellow toner for an electrophotographic imaging apparatus is provided where the toner includes: a binder resin; a pigment; and a charge control agent, wherein the pigment comprises 2-8% by weight of Pigment yellow 74 based on the weight of the toner. The toner is uniform and has small differences between toner particles in performance such as charge amount and has a long press life when used in a non-contact developing method, thereby allowing for high quality images.

### CROSS-REFERENCE TO RELATED PATENT APPLICATIONS

This application claims the benefit of Korean Patent Application No. 10-2005-0003186, filed on Jan. 13, 2005, in the Korean Intellectual Property Office, the disclosure of which is incorporated by reference in its entirety.

### BACKGROUND OF THE INVENTION

1. Field of the Invention

The present invention relates to a toner for an electrophotographic imaging apparatus, and more particularly, to a uniform toner for an electrophotographic imaging apparatus The toner has small differences between toner particles in performance such as charge amount and has a long press life when used in a non-contact developing method, thereby enabling high quality images.

2. Description of the Related Art

FIG. 1 is a schematic view of a conventional electrophotographic imaging apparatus used in a non-contact developing method, which operates as described below. A photoreceptor 1 is charged by a charging unit 6, and then an electrostatic latent image is formed on the photoreceptor 1 by exposing an image to light through a laser scanning unit (LSU) 9. A non-magnetic toner 4 is supplied to a developing roller 2 by a supply roller 3. The non-magnetic toner 4 supplied to the developing roller 2 is laminated to a uniform thickness by a toner layer regulator 5 and simultaneously, charged by vigorous friction. Then, the laminated toner is developed into the electrostatic latent image formed on the photoreceptor 1, and then the developed toner is transferred to a sheet of paper by a transfer roller (not shown) and fused to a fusing unit (not shown). A cleaning blade 7 cleans any residual toner 8 that remains after the transferring of the photoreceptor image.

Various physical, chemical and thermal properties are required for a toner used in the electrophotographic imaging apparatus described above. Particularly, the toner should allow for low energy consumption, high speed, high quality image, and reduced environmental load. Various pigments and waxes are used to satisfy such requirements.

However, the pigments and waxes adversely affect the color reproducibility of an image and charging property, thereby reducing the developing properties of the toner. Further, the pigments and waxes change viscoelasticity and the surface energy of the toner, thereby changing its fusing property. Various organic pigments, such as pigment yellow 17, 180, and 185, etc. are used in conventional yellow toners. However, when these pigments are heated, various byproducts including nitrogen are generated by the decomposition. Further, these pigments have low coloring ability and low dispersibility in the toner.

To overcome these problems, Pigment yellow 74 was suggested as a pigment for the yellow toner. A master batch in which Pigment yellow 74 is dispersed in a high concentration of 30% or greater in a resin was used to prepare the toner having 3-5% of total pigments. However, when the Pigment yellow 74 was used, the charging property of the toner decreased and the viscoelasticity of the toner was changed. Thus, the Pigment yellow 74 cannot be used in the toner for electrophotographic imaging apparatus.

### SUMMARY OF THE INVENTION

The present invention provides a high performance toner for an electrophotographic imaging apparatus which can overcome the above problems and provide a broad range of color reproducibility and an excellent fusing property.

According to an aspect of the present invention, a yellow toner for an electrophotographic imaging apparatus is provided, the toner comprising: a binder resin; a pigment; and a charge control agent, wherein the pigment comprises 2-8% by weight of Pigment yellow 74 based on the weight of the toner.

According to another aspect of the present invention, there is provided a method of developing an image using the toner for an electrophotographic imaging apparatus.

### BRIEF DESCRIPTION OF THE DRAWING

The above and other features and advantages of the present invention will become more apparent by describing in detail exemplary embodiments thereof with reference to the attached drawing in which:

FIG. 1 is a schematic view of a conventional electrophotographic imaging apparatus used in a non-contact developing method.

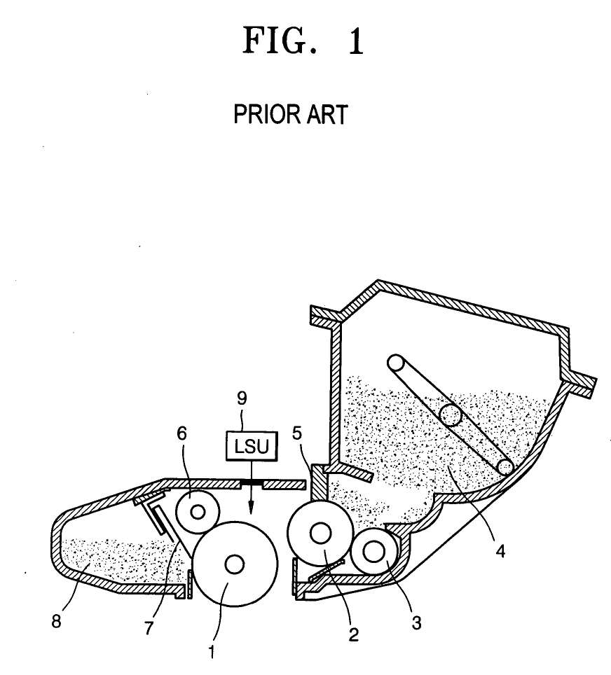

### DETAILED DESCRIPTION OF THE INVENTION

Hereinafter, embodiments of the present invention will now be described in more detail.

The present invention provides a yellow toner for an electrophotographic imaging apparatus, the toner comprising: a binder resin; a pigment; and a charge control agent, wherein the pigment comprises 2-8% by weight of Pigment yellow 74 based on the weight of the toner.

Pigment yellow 74 is a monoazo-based pigment classified according to an international color index (C.I. No. 11741, CAS No. 6358-31-2).

Examples of the binder resin that can be used in an embodiment of the present invention include, but are not limited to, polystyrene-co-butadiene, polystyrene-co-acrylonitrile, modified acrylic polymer, polyvinyl acetate, styrene-alkyd resins, soya-alkyl resins, polyvinylchloride, polyvinylidene chloride, polyacrylonitrile, polycarbonates, polyacrylic acid, polyacrylates, polymethacrylates, styrene polymers, polyvinyl butyral, alkyd resins, polyamides, polyurethanes, polyesters, polysulfons, polyethers, polyketones, phenoxy resins, epoxy resins, silicone resins, polysiloxanes, poly(hydroxyether) resins, polyhydroxystyrene resins, Novolak, poly(phenylglycidylether)-co-dicyclopentadiene, copolymers of the monomers used in the foregoing polymers, and combinations thereof.

The toner may have a ratio of a storage modulus at 100° C./a storage modulus at 150° C. (E′100/E′150) in a range of 100-1000 and a ratio of a storage modulus at 150° C./a storage modulus at 180° C. (E′150/E′180) in a range of 1-10.

As a result of the storage modulus, the toner should be dissolved in order to fuse on a sheet of paper at 100-150° C. and when E′100/E′150 is 100-1000, excellent fusing properties can be attained. Further, after the toner is dissolved, E′ should be maintained in order to prevent hot offset even though the temperature increases. Thus, advantageously, the ratio of E′150/E′180 is small. In one embodiment, the ratio is in the range of 1-10.

To maintain the ratios in the ranges described above, ΔE′ at 100-150° C. and ΔE′ at 150-180° C. should be increased.

For this, a binder resin having a functional group which interacts with the pigment at a high temperature (150° C.) may be used. In one preferred embodiment, the binder resin is a polyester resin having a ratio of a weight average molecular weight to a number average molecular weight (M_{w}/Mₙ) of 10 or greater and an acid value and a hydroxyl value of 3 mgKOH/g or greater, respectively, with a sum of the acid value and the hydroxyl value being 15 or greater.

The pigment that can be used in an embodiment of the present invention is a yellow pigment classified as Pigment yellow 74 where the concentration of the pigment is 2-8% by weight based on the weight of the toner. If the concentration of the pigment is less than 2% by weight based on the weight of the toner, an optical density decreases. If the concentration of the pigment is greater than 8% by weight based on the weight of the toner, the modulus of the toner increases and thus good fusing properties cannot be obtained. A pigment concentration greater than 8% by weight causes the clarity of an image to decrease and thus good coloring cannot be attained. More preferably, the concentration of the pigment is 2.5-5% by weight based on the weight of the toner. The dispersibility of the pigment in the toner, the optical density during printing an image, and the modulus increase when the pigment is within this range.

Although the pigment may be added after being mixed with other raw materials used in the preparation of the toner, it is advantageous to add the pigment using a master batch containing the pigment and a resin in a ratio of 30/70-50/50, since the dispersibility of the pigment can be increased. The resin used in the master batch may be the same as the binder resin used in the toner. As long as it does not have an adverse effect on the characteristics of the toner, a special purpose resin which can increase the dispersibility of the pigment may be used.

A binder used in the master batch of the pigment is not limited to resins. A wax master batch can be used in which a wax used for a toner is used as a base. The wax master batch may be obtained by adsorbing pigment particles on the surface of fine particulate wax particles having a size of 0.1-5 μm in water or an organic solvent, or dispersing the pigment and the wax in a ratio of about 3/7-5/5 with a high shear force as in a conventional master batch containing a resin.

The wax used together with the pigment in the master batch is not specifically limited as long as it can form a master batch together with the pigment. The wax used in the master batch may include at least one wax selected from the group consisting of polyolefin wax, such as polyethylene or polypropylene, and/or its modified product, paraffin wax, hydrocarbon-based wax prepared using a Fisher Tropsh method, carnauba, rice ester wax, and synthetic ester-based wax. These waxes can prevent high and/or low temperature offset during fusing of the toner and increase durability of the toner. The concentration of the wax may be 0.5-8% by weight based on the weight of the toner. In this case, the above effects can be increased further.

As described above, the releasing agent, i.e., wax, may be added to the toner in the form of the master batch containing the pigment and the wax. The wax may be further added using conventional methods. In this case, in order to maintain the effect of using the wax master batch, the amount of the wax further added using the conventional method must be less than the amount of the wax added in the form of the master batch.

The charge control agent used in an embodiment of the present invention must not react with a functional residual group of the binder resin in the toner, for example, a polyester in the binder resin. The binder resin must be able to adjust the viscoelasticity of the resin to a predetermined value before and after melting and kneading.

Specific examples of the charge control agent which can satisfy the above conditions include, but are not limited to, at least one selected from the group consisting of a Zn or Al complex of salicylic acid, a boron complex of bisdiphenyl glycolic acid, and silicates. A charge control agent containing heavy metals is not suitable for the toner, since heavy metal charge control agents react with the binder resin to increase the storage modulus of the toner.

The concentration of the charge control agent may vary according to the type of the charge control agent and may be generally 0.1-6% by weight, preferably 0.5-4% by weight, based on the weight of the toner.

The charge control agent has a low dispersibility in a resin, and when the charge control agent is used in the form of a master batch, its dispersibility can be increased. The master batch containing the charge control agent may be prepared using a conventional method. In this method, 80-50% by weight of a resin is mixed with 20-50% by weight of the charge control agent, and the resultant mixture is heated to a melting point of the resin or higher, and then a shear force is applied to the heated mixture to disperse the charge control agent in the resin. The wax master batch may be prepared by attaching fine particles of the charge control agent uniformly dispersed in a solvent to surfaces of fine wax particles emulsified in water or an organic solvent and thereafter filtering and drying the resultant product.

The toner according to an embodiment of the present invention may further comprise at least one external additive, in addition to the binder resin, the pigment, and the charge control agent. The external additive may be at least two silica components having different average particle diameters, i.e., surface areas according to the BET method.

The purpose of adding the at least two silicas having different average particle diameters to the toner is to control the charge amount and increase the durability. The process of using silicas having different particle diameters is the subject of a commonly owned patent application. In the present embodiment of the present invention, when a silica having a single particle diameter is used, the charge amount cannot be easily controlled and the durability cannot be increased. The sizes of the silicas added can be expressed in an average particle diameter or a surface area (m²/g) according to the BET method. To attain the above effects, among the at least two silicas, a first silica component having a smaller average particle diameter may have a surface area of 200-400 m²/g and a second silica component having a large average particle diameter may have a surface area of 50-180 m²/g.

The silicas may have their surfaces hydrophobized with a treating agent. Examples of the treating agent include, but are not limited to, a silane coupling agent such as HMDS, a silicone oil such as polydialkyl siloxane, or a mixture thereof.

In addition to the silicas, the external additive may be hydrophobized titanium oxide, an oxide of metal (for example, alumina, cerium oxide, barium titanate, or strontium titanate), metallic soap (for example, zinc stearate), and fine spherical particles of resin. The external additive may be sieved using a 100-200 mesh sieve.

The silicas may be added not only as an external additive as described above, but also as an internal additive during mixing of materials of the toner. The silicas added as the external additive may be different from the silicas added as the internal additive during the mixing of the materials, but it is preferable that at least one of the silicas is identical.

Most of the silicas added during the mixing of the materials are present in the toner. A portion of the silicas is present near a surface of the toner which contributes to the charging of the toner and durability of the toner. Thus, when the at least one of the silicas externally added is the same as the silicas internally added, interactions between the silicas are reduced and physical properties of the toner can be efficiently controlled.

In mixing the materials of the toner described above, first the materials in the form of powders are uniformly mixed in predetermined ratios in a mixer such as a Henschel mixer. The resultant mixture is kneaded in a twin-screw extruder, an open continuous kneader, a continuous-type hot kneader, for example, 2 or 3-roller, or a batch-type hot kneader, for example, a kneader. The kneaded product is cooled and subjected to a first milling to produce a first particulate component having an average particle diameter of 200-800 μm. In the first milling, the average particle diameter can be 15-20 μm according to performance of a mill. Then, the milled product is further milled using an impact mill or a mechanical mill, preferably a mechanical mill, and the excessively milled, fine powders are removed using classifying means. Thus, a toner having an average particle diameter of 4-10 μm, preferably 4.5-9.5 μm is obtained.

In an embodiment of the present invention, a method of developing an image using the above toner is provided.

In particular, the toner according to an embodiment of the present invention can be more efficiently used in a non-contact developing method in which a gap is substantially present between a photoreceptor and a developing roller. In general, developing methods includes a two-component developing method in which a mixture of a carrier and the toner is used and a contact developing method in which a photoreceptor substantially contacts a developing roller. However, the toner according to an embodiment of the present invention is suitably used in the non-contact developing method, in which a developing blade is used to form a uniform toner layer on the developing roller and a strong stress is applied to the toner, since the toner has high durability and can efficiently prevent filming on the developing blade.

When an image is developed using the non-contact developing method, a gap between a photoreceptor and a developing roller may be 50-400 μm, preferably 100-300 μm.

If the gap between the photoreceptor and the developing roller is less than 50 μm, the developing amount increases or the toner is attached to the background, thereby decreasing the image quality. If the gap between the photoreceptor and the developing roller is greater than 400 μm, the toner cannot be developed on the photoreceptor and the image cannot be formed.

Hereinafter, the present invention will be described in more detail with reference to the following examples. However, these examples are given for the purpose of illustration and are not intended to limit the scope of the invention.

### EXAMPLE

A master batch composed of 50% by weight of carnauba wax and 50% by weight of pigments was dispersed in water. The pigments included carbon black as a black pigment, Pigment yellow 74 as a yellow pigment, Pigment red 57:1 as a magenta pigment, and Pigment blue 15:3 as a cyan pigment.

The master batch was adjusted such that a total concentration of the pigment and the wax in the toner was 3% by weight. A polyester resin having an acid value of 10 mgKOH/g (Mw/Mn=30) was used as the binder resin. 1% by weight of a boron complex of bisdiphenyl glycolic acid was added as a charge control agent. 0.3% by weight of silica having a BET surface area of 200 m²/g and its surface hydrophobized with a silane coupling agent was used as an internal additive.

The resultant mixture was mixed in a Henschel mixer for 3 minutes and dissolved and kneaded in a twin-screw extruder, and then milled to 30 μm. The milled product was further milled using a mechanical mill with a rotator rotating at high speed. The resulting milled product was classified using a classifier applying a Koander effect. Thus, a four-color toner having an average particle diameter of 6.2 μm was obtained.

Then, 1% by weight of the same silica as used as the internal additive during the preparation of the above mixture,1% by weight of silica having a BET surface area of 50 m²/g and its surface hydrophobized with a silane coupling agent, and 0.5% by weight of titanium oxide (TiO₂) having its surface hydrophobized were externally added to the above four-color toner in the Henschel mixer to obtain a toner.

The toner was loaded on a full-color printer (CLP-500, Samsung Electronics Co., Ltd.) which operates in a non-contact developing manner and an image was printed. The toner allowed a high quality full-color image in a stable manner even after at least 5000 sheets of paper were printed.

### COMPARATIVE EXAMPLE

A master batch composed of 60% by weight of polyester (acid value=10 mgKOH/g, Mw/Mn=30) and 40% by weight of pigments was prepared using a conventional kneading method. The pigments included carbon black as a black pigment, Pigment yellow 74 as a yellow pigment, Pigment red 57:1 as a magenta pigment, and Pigment blue 15:3 as a cyan pigment.

The master batch was adjusted such that the concentration of the pigments in the toner was 3% by weight. A polyester resin having an acid value of 10 mgKOH/g (Mw/Mn=30), which was the same as in preparing the master batch, was used as a binder resin. 1% by weight of a boron complex of bisdiphenyl glycolic acid was added as a charge control agent. 3% by weight of carnauba wax was added as a wax.

The resultant mixture was mixed in a Henschel mixer for 3 minutes and dissolved and kneaded in a twin-screw extruder, and then milled to 30 μm. The milled product was further milled using a mechanical mill with a rotator rotating at high speed. The resulting milled product was classified using a classifier applying a Koander effect. Thus, a four-color toner having an average particle diameter of 6.2 μm was obtained.

Then, 1% by weight of silica having a BET surface area of 200 m²/g and its surface hydrophobized with a silane coupling agent, 1% by weight of silica having a BET surface area of 50 m²/g and its surface hydrophobized with a silane coupling agent, and 0.5% by weight of titanium oxide (TiO₂) having its surface hydrophobized were externally added to the above four-color toner in the Henschel mixer to obtain a toner.

The toner was loaded on a full-color printer (CLP-500, Samsung Electronics Co., Ltd.) which operates in a non-contact developing manner and an image was printed. After about 2000 sheets of paper were printed, the image was thinner and image defects were generated.

According to the present invention, a uniform toner for an electrophotographic imaging apparatus, which has small differences between toner particles in performance such as charge amount is provided. The toner has high durability and stability and can stably print high quality full-color images on a large amount of paper. In particular, the toner has a long press life when used in a non-contact developing method, thereby allowing for high quality images

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A yellow toner for an electrophotographic imaging apparatus, the toner comprising:
a binder resin;
a pigment; and
a charge control agent,
wherein the pigment comprises 2-8% by weight of Pigment yellow 74 based on the weight of the toner.

2. The yellow toner of claim 1, wherein the binder resin is selected from the group consisting of polystyrene-co-butadiene, polystyrene-co-acrylonitrile, modified acrylic polymer, polyvinyl acetate, styrene-alkyd resins, soya-alkyl resins, polyvinylchloride, polyvinylidene chloride, polyacrylonitrile, polycarbonates, polyacrylic acid, polyacrylates, polymethacrylates, styrene polymers, polyvinyl butyral, alkyd resins, polyamides, polyurethanes, polyesters, polysulfons, polyethers, polyketones, phenoxy resins, epoxy resins, silicone resins, polysiloxanes, poly(hydroxyether) resins, polyhydroxystyrene resins, Novolak, poly(phenylglycidylether)-co-dicyclopentadiene, a copolymer of the monomers used in the foregoing polymers, and combinations thereof.

3. The yellow toner of claim 1, having a ratio of a storage modulus at 100° C./a storage modulus at 150° C. in a range of 100-1000 and a ratio of a storage modulus at 150° C./a storage modulus at 180° C. in a range of 1-10.

4. The yellow toner of claim 1, wherein the binder resin is a polyester resin having a ratio of a weight average molecular weight to a number average molecular weight of 10 or greater and an acid value and a hydroxyl value of 3 mgKOH/g or greater, respectively.

5. The yellow toner of claim 1, wherein the concentration of the Pigment yellow 74 is 2.5-5% by weight based on the weight of the toner.

6. The yellow toner of claim 1, wherein the Pigment yellow 74 is added using a master batch containing the pigment and a resin in a ratio of 30/70-50/50.

7. The yellow toner of claim 6, wherein the master batch is a wax master batch containing a wax as a base.

8. The yellow toner of claim 7, wherein the wax includes at least one wax selected from the group consisting of polyolefin wax and/or its modified product, the polyolefin wax being selected from polyethylene and polypropylene, paraffin wax, hydrocarbon-based wax prepared using a Fisher Tropsh method, carnauba, rice ester wax, and synthetic ester-based wax.

9. The yellow toner of claim 7, wherein the concentration of the wax is 0.5-8% by weight based on the weight of the toner.

10. The yellow toner of claim 1, wherein the charge control agent includes at least one selected from the group consisting of a Zn or Al complex of salicylic acid, a boron complex of bisdiphenyl glycolic acid, and silicates.

11. The yellow toner of claim 1, wherein the concentration of the charge control agent is 0.1-6% by weight based on the weight of the toner.

12. The yellow toner of claim 1, wherein the concentration of the charge control agent is 0.5-4% by weight based on the weight of the toner.

13. The yellow toner of claim 1, wherein the charge control agent is added using a master batch obtained by mixing 80-50% by weight of the binder resin and 20-50% by weight of the charge control agent.

14. The yellow toner of claim 1, further comprising at least one external additive.

15. The yellow toner of claim 14, wherein the external additive is at least two silica components having different average particle diameters.

16. The yellow toner of claim 15, wherein among the at least two silica components, a first silica component has a smaller average particle diameter with a surface area of 200-400 m²/g and a second silica component has a large average particle diameter with a surface area of 50-180 m²/g.

17. The yellow toner of claim 15, wherein the silicas have their surfaces hydrophobized with a silane coupling agent, a silicone oil, or a mixture thereof.

18. The yellow toner of claim 14, wherein the external additive includes at least one additive selected from the group consisting of hydrophobized titanium oxide, an oxide selected from alumina, cerium oxide, barium titanate, and strontium titanate; metallic soap, and fine spherical particles of resin.

19. The yellow toner of claim 14, wherein the external additive is further added as an internal additive during mixing of the binder resin, the pigment, and the charge control agent.

20. A method of developing an image using the yellow toner of claim 1 in an electrophotographic imaging apparatus.

21. The method of claim 20, which is a non-contact developing method.

22. The method of claim 21, wherein a gap between a photoreceptor and a developing roller is 50-400 μm.

23. The method of claim 21, wherein a gap between a photoreceptor and a developing roller is 100-300 μm.
